(19) United States
(12) Patent Application Publication
(10) Pub. No.: US 2010/0004855 A1
(43) Pub. Date: Jan. 7, 2010

(54) Geographic Information Updating Device for a Navigation System and Related Navigation System

(76) Inventors: Chih-Ming Liao, Taipei Hsien (TW); Chen-Hao Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/207,501

(22) Filed: Sep. 10, 2008

(30) Foreign Application Priority Data
Jul. 7, 2008 (TW) 097125543

(51) Int. Cl. G01C 21/26; H04N 5/225

(52) U.S. Cl. 701/208; 701/200; 348/207.99; 348/E05.024

(57) ABSTRACT

A geographic information updating device for enhancing precision of geographic information in a navigation system, the navigation system including a geographic information database for storing at least one geographic data, the geographic information updating device includes an image database, an image capturing unit, an image comparing unit and a processing unit. The image database is utilized for storing a plurality of road image data. The image capturing unit is utilized for capturing an image data. The image comparing unit is utilized for comparing the image data captured by the image capturing unit and the plurality of road image data stored in the image database, so as to generating a comparing result. The processing unit is coupled to the image comparing unit and the geographic information database, for updating the at least one geographic data of the geographic information database according to the comparing result.

### BACKGROUND OF THE INVENTION

1. Field of the Invention

The present invention relates to a geographic information updating device for a navigation system and related navigation system, and more particularly, to a geographic information updating device for a navigation system and related navigation system for enhancing accuracy of geographic information utilizing image identification technology.

2. Description of the Prior Art

With progress of technology, the Portable Navigation Device is more popular in the market, and is adapted by customers more widely. For example, many cars are installed with the Personal Navigation Device for positioning, fixing orientation or determining a route for driving.

Generally speaking, the Portable Navigation Device determines a route or navigates according to users' requirements on the basis of stored geographic information. However, if the geographic information is out of date, or if road conditions have changed, e.g. a newly-constructed road or a road under construction, the Portable Navigation Device may determine an incorrect route, e.g. including a closed road in the route, or be incapable of determining a route, causing inconvenience for the users.

### SUMMARY OF THE INVENTION

It is therefore a primary objective of the claimed invention to provide a geographic information updating device for a navigation system and related navigation system for enhancing accuracy of geographic information.

The present invention discloses a geographic information updating device in a navigation system. The navigation system includes a geographic information database for storing at least one geographic data. The geographic information updating device comprises an image database, an image capturing unit, an image comparing unit and a processing unit. The image database is utilized for storing a plurality of road image data. The image capturing unit is utilized for capturing an image data. The image comparing unit is utilized for comparing the image data captured by the image capturing unit and the plurality of road image data stored in the image database, so as to generate a comparing result. The processing unit is coupled to the image comparing unit and the geographic information database, and is utilized for updating the at least one geographic data of the geographic information database according to the comparing result.

The present invention further discloses a navigation system, which comprises a display device, a positioning device, a geographic information database, a navigation processor and a geographic information updating device.

The positioning device is utilized for generating a positioning information corresponding to the navigation system via a Global Positioning System. The geographic information database is utilized for storing at least one geographic data. The navigation processor is coupled to the display device, the positioning device and the geographic information database, and is utilized for displaying a navigation result on the display device according to the positioning information. The geographic information updating device comprises an image database, an image capturing unit, an image comparing unit and a processing unit. The image database is utilized for storing a plurality of road image data. The image capturing unit is utilized for capturing an image data. The image comparing unit is utilized for comparing the image data captured by the image capturing unit and the plurality of road image data stored in the image database, so as to generate a comparing result. The processing unit is coupled to the image comparing unit and the geographic information database, and is utilized for updating the at least one geographic data of the geographic information database according to the comparing result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a navigation system according to an embodiment of the present invention.

FIG. 2 is a schematic diagram of the navigation system installed in a vehicle.

FIG. 3 is a schematic diagram of a road sign image data.

FIG. 4 is a schematic diagram of a road word image data.

FIG. 5 is a schematic diagram of a road condition according to an embodiment of the present invention.

FIG. 6 is a schematic diagram of a road sign with road figures and road words.

### DETAILED DESCRIPTION

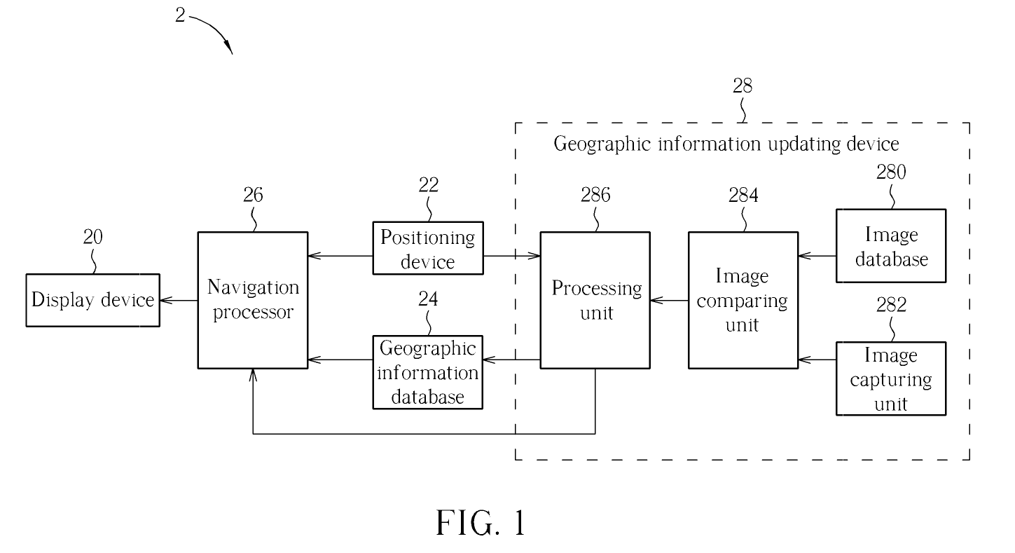

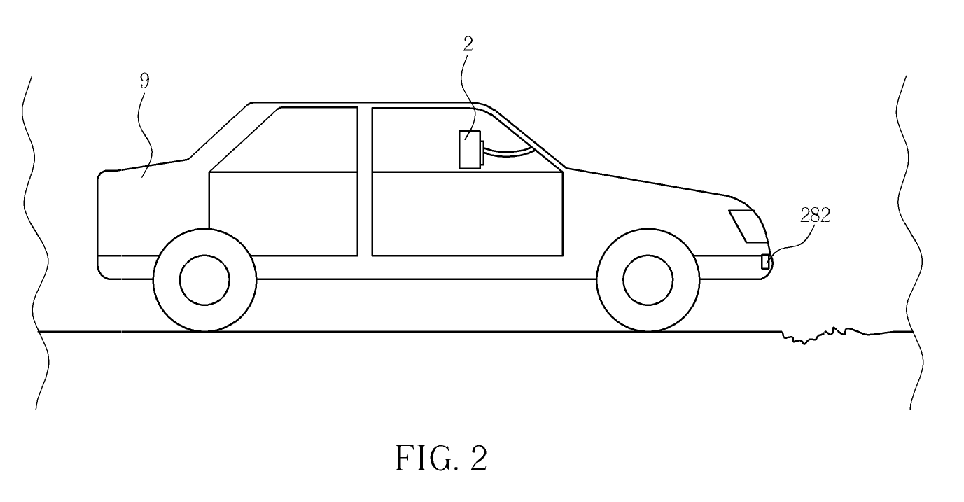

Please refer to FIG. 1 and FIG. 2. FIG. 1 is a functional block diagram of a navigation system 2 according to an embodiment of the present invention, and FIG. 2 is a schematic diagram of the navigation system 2 installed in a vehicle 9. The navigation system 2 can determine road conditions by image identification technology, and adjust navigation geographic information accordingly, so as to enhance accuracy of the geographic information. The navigation system 2 comprises a display device 20, a positioning device 22, a geographic information database 24, a navigation processor 26 and a geographic information updating device 28. The display device 20 is utilized for displaying related information of navigation, including geographic information and word information, and can be a CRT monitor, a LCD monitor, or a plasma monitor. The positioning device 22 is utilized for generating a positioning information corresponding to the navigation system 2 via a Global Positioning System. In short, the positioning device 22 can provide the positioning information of the present position of the navigation system 2. The geographic information database 24 is utilized for storing at least one geographic data. The navigation processor 26 is coupled to the display device 20, the positioning device 22 and the geographic information database 24, and is utilized for displaying a navigation result on the display device 20 according to the positioning information generated by the positioning device 22. Since operation of navigation is well known in the industry, description thereof is omitted here. Besides, the geographic information updating device 28 comprises an image database 280, an image capturing unit 282, an image comparing unit 284 and a processing unit 286.

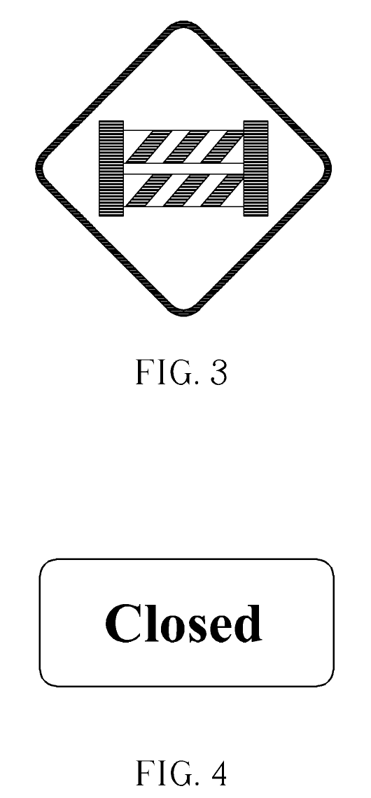

The image database 280 is utilized for storing a plurality of road image data, which comprises a road line image data, a road sign image data and a road word image data. The road line image data can be traffic lines on the road, such as a white sideline, a yellow road line, a red road line, or a center line. The road sign image data comprises road signs usually seen, such as a “road closed” road sign shown in FIG. 3. The road word image data comprises road words usually seen, such as the word “Closed” shown in FIG. 4.

The image capturing unit 282 is utilized for capturing image data, and can be a video camera or a camera. Position of the image capturing unit 282 as installed in the vehicle 9 can be seen in FIG. 2. The image comparing unit 284 is utilized for comparing the image data captured by the image capturing unit 282 and the plurality of road image data stored in the image database 280, so as to generate a comparing result. In other words, the image comparing unit 284 determines road conditions by image identification technology, and generates the comparing result accordingly. The processing unit 286 is coupled to the image comparing unit 284 and the geographic information database 24, and is utilized for updating the at least one geographic data of the geographic information database 24 according to the comparing result generated by the image comparing unit 284.

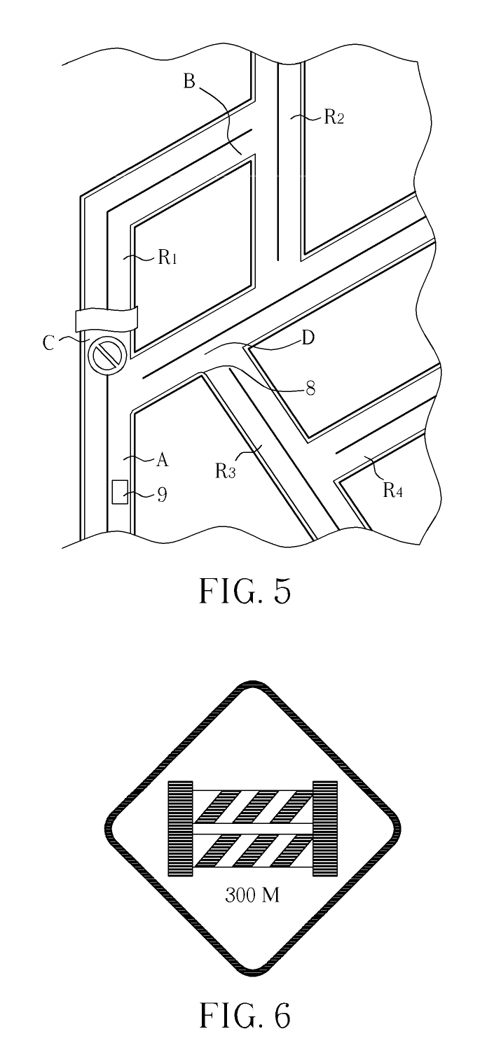

Please refer to FIG. 5. FIG. 5 is a schematic diagram of a road situation according to an embodiment of the present invention. In FIG. 5, the vehicle 9 is originally routed from a place A to a place B through a road R₁, but a place C is under construction, thus causing the road R₁ to be closed. When the vehicle 9 approaches the place C, the image capturing unit 282 will capture image data ahead. If a road sign shown in FIG. 3 is set on the place C, the image capturing unit 282 will capture an image of the road sign, and will transmit the image of the road sign to the image comparing unit 284. The image comparing unit 284 can compare the image transmitted from the image capturing unit 282 with the road image data stored in the image database 280, so as to generate a comparing result indicating that the road is closed. Then, the image comparing unit 284 will transmit the comparing result to the processing unit 286, and the processing unit 286 will update the geographic data of the geographic information database 24 according to the comparing result and the positioning information generated by the positioning device 22, that is, marking the road R₁ and the place C closed. At the same time, the processing unit 286 can send an indicating information to the navigation processor 26, and the navigation processor 26 will determine a route again to generate a new route, which travels to the place B through the road R₂. Moreover, the processing unit 286 is preferably utilized for generating a warning signal to the navigation processor 26 according to the comparing result, and the navigation processor 26 will generate a warning sound or display related warning words on the display device 20, so as to inform the driver that the road is closed. In the same way, if a road sign with road words shown in FIG. 4 is set on the place C, the image comparing unit 284 can compare the image captured by the image capturing unit 282 with the road image data stored in the image database 280, so as to generate a comparing result indicating that the road is closed. In addition, if a road sign with road figures and road words shown in FIG. 6 is set on the place C, the image comparing unit 284 can also compare the image captured by the image capturing unit 282 with the road image data stored in the image database 280, so as to generate a comparing result indicating that the road is closed. The image comparing unit 284 also transmits the word information of the road sign, e.g. 300M, to the processing unit 286, and the processing unit 286 can indicate the place where the road is closed more precisely according to the word information and the positioning information generated by the positioning device 22.

Besides, in FIG. 5, a road R₃ is a new road, so the road R₃ is not indicated in the geographic information database 24. When the vehicle 9 approaches a place D, the image capturing unit 282 captures the image data, which is the white sideline 8 on the road, and transmits the image data to the image comparing unit 284. The image comparing unit 284 can compare the image data with the road image data stored in the image database 280, and determine that the image data is a right-turn white sideline 8, so as to generate a comparing result indicating that there is a crossroad. Then, the image comparing unit 284 will transmit the comparing result to the processing unit 286, and the processing unit 286 will update the geographic data of the geographic information database 24 according to the comparing result and the positioning information generated by the positioning device 22, that is, marking the place D as a crossroad. In such a situation, since the vehicle 9 is not driven into the new road R₃, related data of the road R₃ can not be indicated in the geographic data of the geographic information database 24. However, if the vehicle 9 is driven into the new road R₃, the processing unit 286 can update the geographic data of the geographic information database 24 according to the positioning information generated by the positioning device 22, and the related data of the road R₃ can be indicated in the geographic information database 24. At the same time, more detailed related data of the road R₃ can be obtained via the image capturing unit 282 and the image comparing unit 284. For example, another new road R₄ can be detected. Please note that, if there are any road lines on the road R₃, the road line can also be detected and be indicated in the geographic information database 24.

Please note that the position of the image capturing unit 282 installed in the vehicle 9 shown in FIG. 2 is just an exemplary embodiment, and is not limited. Also, the image capturing unit 282 can transmit the image data captured to the image comparing unit 284 by wired or wireless communication. Moreover, the image capturing unit 282 can be integrated with other components, e.g. the image comparing unit 284, the processing unit 286 and the navigation processor 26, and thus the navigation system 2 can not only be installed in the vehicle 9, but can also be carried by the user, such that the user can record road conditions on foot.

In conclusion, the navigation system of the present invention can determine road conditions by image identification technology, and adjusts navigation geographic information accordingly, so as to enhance accuracy of the geographic information.

Those skilled in the art will readily observe that numerous modifications and alterations of the device and method may be made while retaining the teachings of the invention.

What is claimed is:

1. A geographic information updating device in a navigation system, the navigation system including a geographic information database for storing at least one geographic data, the geographic information updating device comprising:
an image database for storing a plurality of road image data;
an image capturing unit for capturing an image data;
an image comparing unit for comparing the image data captured by the image capturing unit and the plurality of road image data stored in the image database, so as to generate a comparing result; and
a processing unit coupled to the image comparing unit and the geographic information database, for updating the at least one geographic data of the geographic information database according to the comparing result.

2. The geographic information updating device of claim 1, wherein the plurality of road image data comprises a road line image data.

3. The geographic information updating device of claim 1, wherein the plurality of road image data comprises a road sign image data.

4. The geographic information updating device of claim 1, wherein the plurality of road image data comprises a road word image data.

5. The geographic information updating device of claim 1, wherein the processing unit is further coupled to a positioning device of the navigation system, and the positioning device is utilized for generating a positioning information corresponding to the navigation system via a Global Positioning System.

6. The geographic information updating device of claim 5, wherein the processing unit updates the at least one geographic data of the geographic information database according to the positioning information and the comparing result.

7. The geographic information updating device of claim 1, wherein the image capturing unit is a video camera.

8. The geographic information updating device of claim 1, wherein the image capturing unit is a camera.

9. The geographic information updating device of claim 1, wherein the image capturing unit transmits the image data captured to the image comparing unit by wireless communication.

10. The geographic information updating device of claim 1, wherein the processing unit is further utilized for generating a warning signal according to the comparing result.

11. A navigation system comprising:
a display device;
a positioning device for generating a positioning information corresponding to the navigation system via a Global Positioning System;
a geographic information database for storing at least one geographic data;
a navigation processor coupled to the display device, the positioning device and the geographic information database, for displaying a navigation result on the display device according to the positioning information; and
a geographic information updating device comprising:
an image database for storing a plurality of road image data;
an image capturing unit for capturing an image data;
an image comparing unit for comparing the image data captured by the image capturing unit and the plurality of road image data stored in the image database, so as to generate a comparing result; and
a processing unit coupled to the image comparing unit and the geographic information database, for updating the at least one geographic data of the geographic information database according to the comparing result.

12. The navigation system of claim 11, wherein the plurality of road image data comprises a road line image data.

13. The navigation system of claim 11, wherein the plurality of road image data comprises a road sign image data.

14. The navigation system of claim 11, wherein the plurality of road image data comprises a road word image data.

15. The navigation system of claim 11, wherein the processing unit updates the at least one geographic data of the geographic information database according to the positioning information and the comparing result.

16. The navigation system of claim 11, wherein the image capturing unit is a video camera.

17. The navigation system of claim 11, wherein the image capturing unit is a camera.

18. The navigation system of claim 11, wherein the image capturing unit transmits the image data captured to the image comparing unit by wireless communication.

19. The navigation system of claim 11, wherein the processing unit is further utilized for generating a warning signal according to the comparing result.
